(19) United States
(12) Patent Application Publication
(10) Pub. No.: US 2005/0216296 A1
(43) Pub. Date: Sep. 29, 2005

(54) Vehicle common use system, method, and program

(75) Inventor: Mamoru Kokubu, Palm Spring (SG)

Correspondence Address: ARENT FOX PLLC, 1050 CONNECTICUT AVENUE, N.W., SUITE 400, WASHINGTON, DC, 20036, US

(73) Assignee: HONDA MOTOR CO., LTD.

(21) Appl. No.: 11/071,361

(22) Filed: Mar. 4, 2005

(30) Foreign Application Priority Data
Mar. 23, 2004 (JP) 2004-084543
Dec. 6, 2004 (JP) 2004-353088

(51) Int. Cl. G06F 17/60

(52) U.S. Cl. 705/1

(57) ABSTRACT

A vehicle common use system for managing rental and return of a vehicle, the system. The system includes a usage charge computing device for receiving a remaining amount of fuel at a start of rental of the vehicle and a remaining amount of fuel at the return of the vehicle, from an in-vehicle terminal which is mounted on the vehicle and is connected via a communication network, and for giving a credit for fueling of the vehicle by a user when an increase in the remaining amount of fuel from the start of rental to the return, which is obtained by comparing both remaining amounts of fuel, is equal to or greater than a predetermined value. It is possible to encourage refueling of returned vehicles by the users and to reduce the burden on the maintenance staff.

### BACKGROUND OF THE INVENTION

1. Field of the Invention

The present invention relates to a vehicle common use system, method, and program for managing rental and return of vehicles without an attendant by using a computer.

Priority is claimed on Japanese Patent Application No. 2004-084543, filed Mar. 23, 2004, and No. 2004-353088, filed Dec. 06, 2004, the contents of which are incorporated herein by reference.

2. Description of Related Art

Conventionally, numerous techniques have been proposed for managing rental and return of vehicles (e.g., rental cars) by using a computer (see, for example, Japanese Unexamined Patent Application, First Publications Nos. H05-159143 and H06-068095).

In vehicle common use systems for managing rental and return of vehicles without an attendant, the user is not obligated to refuel the returned vehicle after using the vehicle. The usage form is mostly stable and the running distance per day of each vehicle is mostly within a specific range. Therefore, under these circumstances, the maintenance staff performs refueling simultaneously with regular maintenance checking.

Refueling must be performed at a filling or service station; thus, the vehicle must be moved and the maintenance staff bears a burden, and the burden as labor cost is charged to the users. Therefore, if the users refuel the vehicles, such waste can be avoided.

### SUMMARY OF THE INVENTION

In view of the above circumstances, an object of the present invention is to provide a vehicle common use system, method, and program for giving users credit for refueling performed by the user and deducting a corresponding amount from the charge, so as to encourage refueling of returned vehicles by the users and to reduce the burden on the maintenance staff.

Therefore, the present invention provides a vehicle common use system for managing rental and return of a vehicle, the system comprising:

a usage charge computing device for receiving a remaining amount of fuel at a start of rental of the vehicle and a remaining amount of fuel at the return of the vehicle, from an in-vehicle terminal which is mounted on the vehicle and is connected via a communication network, and for giving a credit for fueling of the vehicle by a user when an increase in the remaining amount of fuel from the start of rental to the return, which is obtained by comparing both remaining amounts of fuel, is equal to or greater than a predetermined value.

According to the above structure, the usage charge computing device compares the remaining amount of fuel at the start of rental of the vehicle with the remaining amount of fuel at the return of the vehicle, which are sent from the in-vehicle terminal, and gives a credit for fueling of the vehicle by a user when the increase in the remaining amount of fuel from the start of rental to the return is equal to or greater than a predetermined value. Therefore, it is possible to encourage refueling of returned vehicles by the users and to reduce the burden on the maintenance staff.

Typically, the usage charge computing device receives the remaining amount of fuel at the return of the vehicle via the in-vehicle terminal from a fuel remaining amount measuring device for measuring a remaining amount of fuel, provided in the vehicle, wherein the remaining amount of fuel at the return is a part of rental end data obtained when the vehicle is returned.

In a preferable example, the usage charge computing device receives the remaining amount of fuel at the start of rental of the vehicle and the remaining amount of fuel at the return of the vehicle, which are measured by a fuel remaining amount measuring device, provided in the vehicle, for measuring a remaining amount of fuel, wherein the former remaining amount is a part of rental data obtained when the vehicle is rented and the latter remaining amount is a part of rental end data obtained when the vehicle is returned.

The present invention also provides a vehicle common use method for managing rental and return of a vehicle by using a computer, the method comprising the steps of:

receiving a remaining amount of fuel at a start of rental of the vehicle and a remaining amount of fuel at the return of the vehicle, from an in-vehicle terminal which is mounted on the vehicle and is connected via a communication network; and

giving a credit for fueling of the vehicle by a user when an increase in the remaining amount of fuel from the start of rental to the return, which is obtained by comparing both remaining amounts of fuel, is equal to or greater than a predetermined value.

The present invention also provides a program used in a vehicle common use system for managing rental and return of a vehicle, the program for making a computer execute the steps of:

receiving a remaining amount of fuel at a start of rental of the vehicle and a remaining amount of fuel at the return of the vehicle, from an in-vehicle terminal connected via a communication network; and

giving a credit for fueling of the vehicle by a user when an increase in the remaining amount of fuel from the start of rental to the return, which is obtained by comparing both remaining amounts of fuel, is equal to or greater than a predetermined value.

The present invention also provides a vehicle common use system for managing rental and return of a vehicle, the system comprising in the vehicle:

a remaining amount measuring device for measuring a remaining amount of fuel at the return of the vehicle;

a decreased fuel remaining amount measuring device for measuring a decreased remaining amount of fuel when an engine of the vehicle is stopped during usage of the vehicle;

a fueling credit producing device for giving a credit for fueling of the vehicle by a user when the decreased remaining amount of fuel, measured by the decreased fuel. remaining amount measuring device, is less than a predetermined value (e.g., a reference value for decrease in an embodiment explained below) and the remaining amount of fuel at the return of the vehicle, measured by the remaining amount measuring device, is equal to or greater than a second predetermined value (e.g., a reference value for return in the embodiment); and

a usage charge computing device for computing a usage charge based on a signal which indicates giving of the credit and is issued from the fueling credit producing device, and on data which relates to the usage charge and is provided from a server connected via a communication network.

According to the present invention, the user benefits from a discounted charge, which promotes a system of returning the vehicle after refueling, thereby saving the labor of the maintenance staff. In addition, when refueling is performed at a contract station, the vehicle is checked by a service person at the station, thereby reducing the burden on the maintenance staff. Furthermore, the vehicle can be checked at each time of fueling, thereby improving efficiency of the usage of the rental vehicle.

### BRIEF DESCRIPTION OF THE DRAWINGS

FIG. 1 is a diagram for explaining the structure of a communication infrastructure to which a vehicle common use system according to the present invention is connected.

FIG. 2 is a block diagram showing the internal structure of the vehicle common use system as an embodiment according to the present embodiment.

FIG. 3 is a block diagram showing the structure of an in-vehicle terminal used in the embodiment.

FIG. 4 is a flowchart showing a basic operation performed in the embodiment

FIG. 5 is a flowchart showing a reservation process performed in the embodiment.

FIG. 6 is a flowchart showing a get-in entry process performed in the embodiment.

FIG. 7 is a flowchart showing a vehicle returning process performed in the embodiment.

FIG. 8 is a flowchart showing a usage charge computing process performed in the embodiment.

FIG. 9 is a flowchart showing a usage charge computing process relating to fueling, performed in the embodiment.

### DETAILED DESCRIPTION OF THE INVENTION

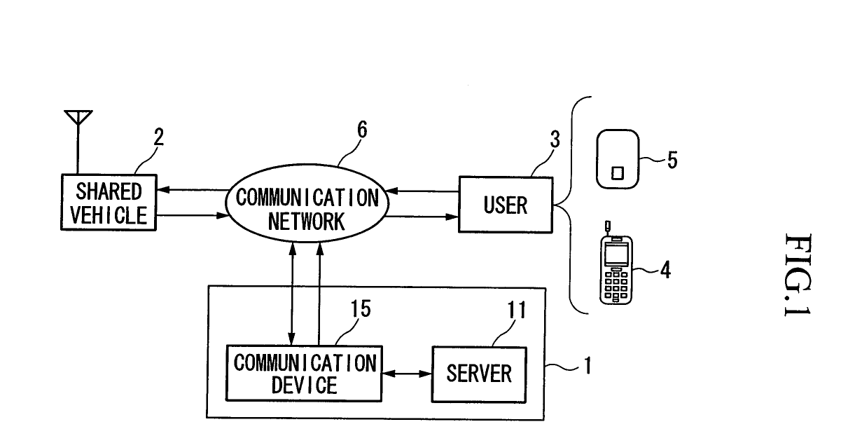

Hereinafter, embodiments according to the present invention will be explained with reference to the drawings. First, a communication infrastructure to which a vehicle common use system according to the present invention is connected will be explained with reference to FIG. 1.

In FIG. 1, reference numeral 1 indicates a management center which has a server 11 for managing common use of shared vehicles 2, such as rental, allocation, and demands for charge for using the vehicles 2 which are commonly used by the users 3 and are parked in parking areas called ports. The management center 1 also has a communication device 15.

The shared vehicles 2 are commonly used by a plurality of users 3 who have been registered as registered members in the server 11. Vehicle management data are exchanged between the shared vehicles 2 and the server 11 provided in the management center 1. Each shared vehicle 2 includes a communication device and a control unit (which are not shown) for exchanging the vehicle management data with the server 11 in the management center 1 and managing rental of the vehicle based on the vehicle management data. Each user 3 has a smart card 5 which stores a unique user ID assigned to each user. When using a shared vehicle 2, the user ID inputs the user ID to the shared vehicle 2 by using the smart card 5. In addition, the user 3 may make a reservation from the user terminal 4 via the communication device 15 to the server 11 so as to use a shared vehicle 2, where data for specifying the vehicle, such as departure/arrival ports, date, time, type of vehicle, and the like, may be designated.

Reference numeral 6 indicates a communication network for connecting the user terminal 4 possessed by each user 3 and the communication device 15 in the management center 1, and also connecting the communication device of each shared vehicle 2 and the communication device 15 in the management center 1. In the communication network, data are communicated via wireless communication using WAP (wireless application protocol), or wired communication using the Internet which uses WWW (world wide web) or a public line network such as PSTN (public switched telephone network) or ISDN (integrated services digital network).

One or more shared vehicles 2 are managed by the management center 1, and the number of the users 3 is not limited. In addition, a plurality of the ports are managed by the management center 1.

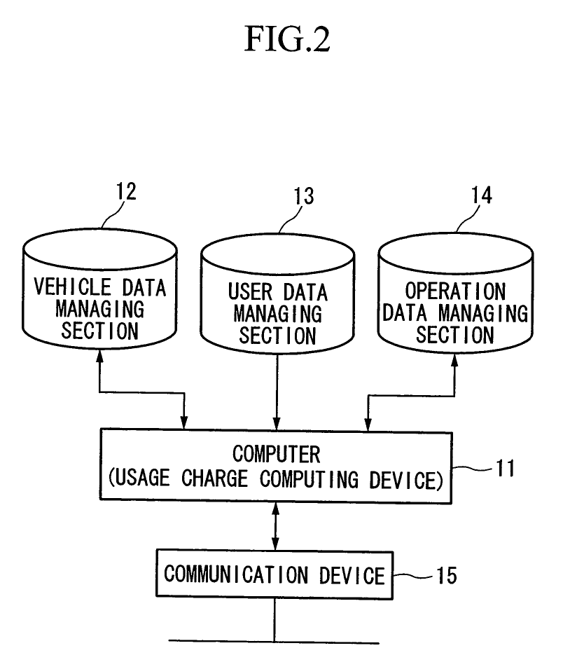

FIG. 2 is a block diagram showing the internal structure of the vehicle common use system in the present embodiment.

The vehicle common use system of the present embodiment has the server 11 which is built in a computer provided in the management center and is a core component, cooperated with a shared vehicle reservation apparatus, for managing the entire process from reservation to return of the vehicle. In the vehicle common use system, a vehicle data managing section 12, a user data managing section 13, an operation data managing section 14, and a communication device 15 are connected to the server (i.e., the computer) 11.

The server 11 also functions as the usage charge computing device of the present invention and receives data of the remaining amount of fuel at the start of usage of the vehicle and the remaining amount of fuel at the return of the vehicle, from a terminal mounted on the vehicle (i.e., an in-vehicle terminal explained below). When the increase in the remaining amount of fuel from the start of usage to the return, which is obtained by comparing the received two remaining amounts, exceeds a predetermined value, the server gives a credit for refueling by the user and adjusts the charge for the credit.

The vehicle data managing section 12 manages vehicle data such as the vehicle number of each rental vehicle which has been reserved. The user data managing section 13 manages personal data such as the driving license number of the user who made the reservation. The operation data managing section 14 manages operation (or service) data such as the use time, the running distance, and the remaining amount of fuel of the rental vehicle. The communication device 15 is an interface for performing wireless communication with an in-vehicle terminal mounted on each rental vehicle.

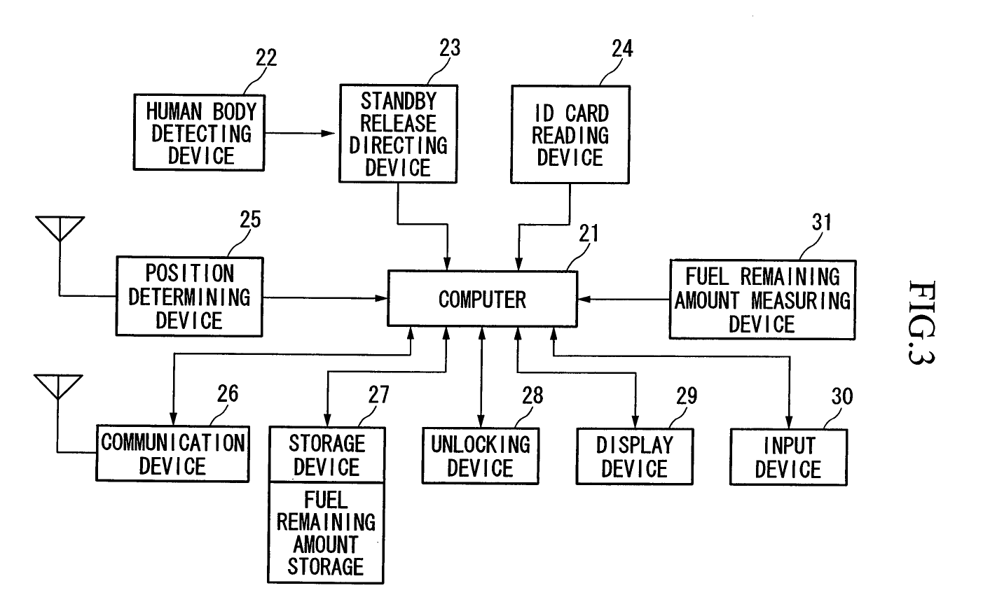

FIG. 3 is a block diagram showing the structure of the shared vehicle reservation apparatus provided in each shared vehicle in FIG. 1.

In FIG. 3, the computer 21 is a control section for exchanging the vehicle management data with the server 11 provided in the management center 1, and for managing rental of each shared vehicle 2 based on the vehicle management data. To the computer 21, the following devices are connected: a position determining device 25 for determining in which port the shared vehicle is presently parking, by using electromagnetic waves received using an antenna, and a communication device 26 having a communication antenna and performing sending/receiving of the vehicle management data via wireless communication with the server 11 in the management center 1. A storage device 27 is also connected, which temporarily stores the vehicle management data which include (i) the vehicle number assigned to each shared vehicle 2, (ii) the user ID of each user 3 who can use the shared vehicle 2, (iii) the user ID or PIN (personal identification number) of the user 3, which is input by the user 3, and (iv) usage condition data which indicate the conditions of the shared vehicle 2 which change momentarily.

To the computer 21, the following are also connected: (i) a standby release directing device 23 for outputting a standby release command to the computer 21 in the standby state when a user 3 approaches a shared vehicle 2, based on a signal from a human body detecting device 22 which has a human body sensor and detects approach of a human body, (ii) a display device 29 for showing the user 3, who approaches the shared vehicle 2, usage possible/impossible information which indicates whether the shared vehicle 2 can be used and which is output from the computer 21, and (iii) an ID card reading device 24 for reading a user ID when the user 3 puts the smart card 5, which has a contactless reading and writing system, onto the ID card reading device 24, and for informing the computer 21 of a signal including the read user ID.

Additionally, the following are also connected to the computer 21: (i) an unlocking device 28 for releasing the door key when a user 3 puts the smart card 5 so as to input the user ID and the computer 21 compares the input user ID with the user ID stored in the storage device 24 and if both coincide with each other, and (ii) an input device 30 for inputting, by the user 3, PIN or the like of the user 3 when the user 3 rents a shared vehicle 2. The display device 29 also displays indications or instructions (by the computer 21) for the user 3, the vehicle management data obtained from the server 11, and the like.

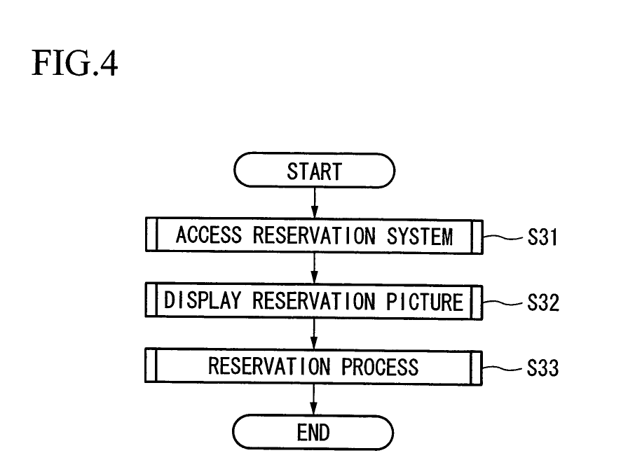

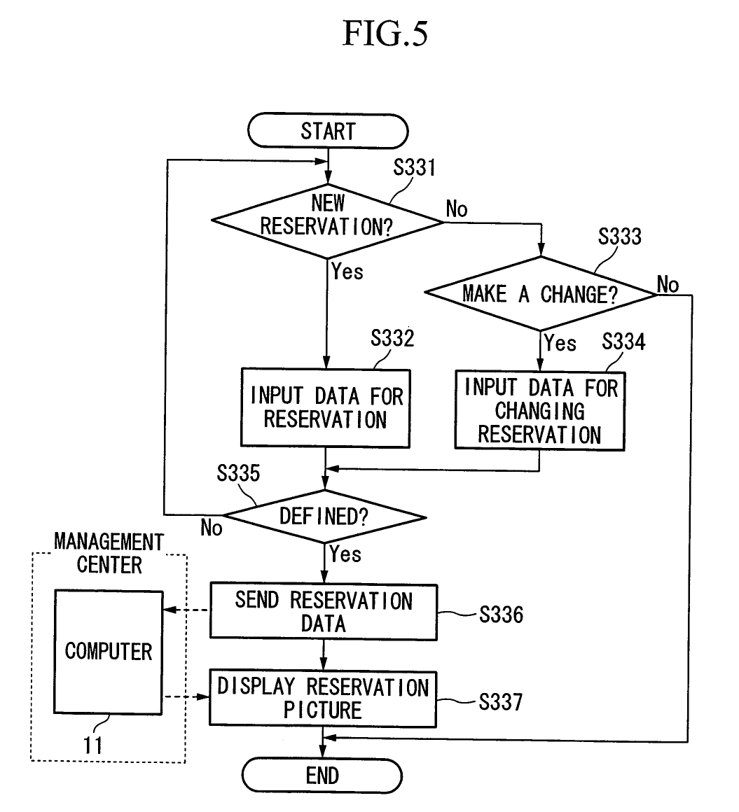

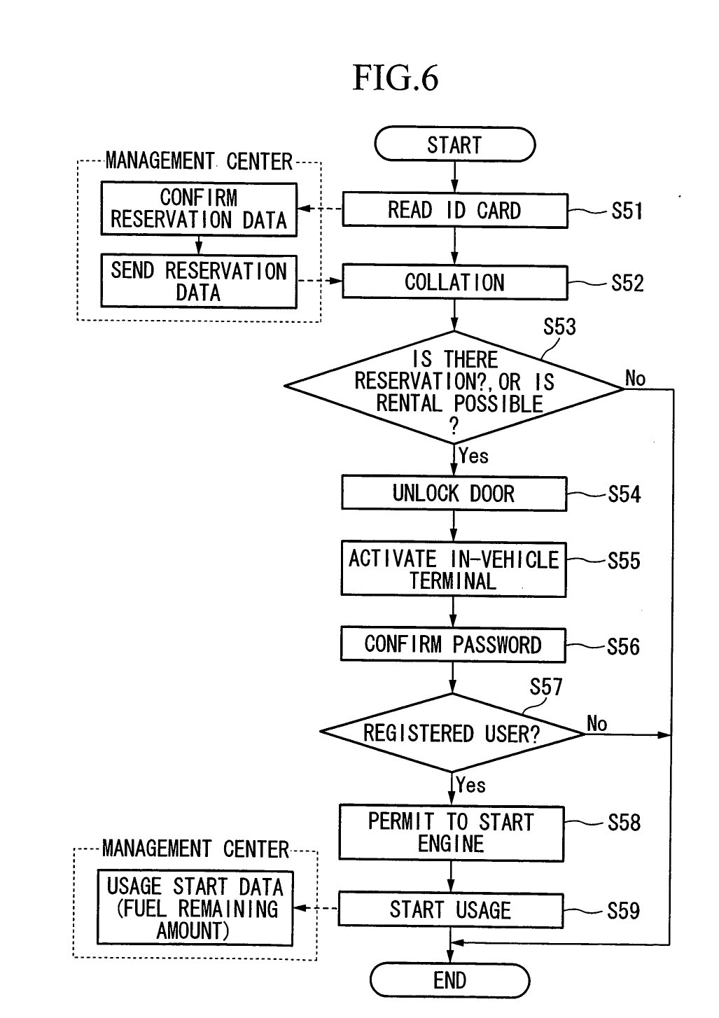

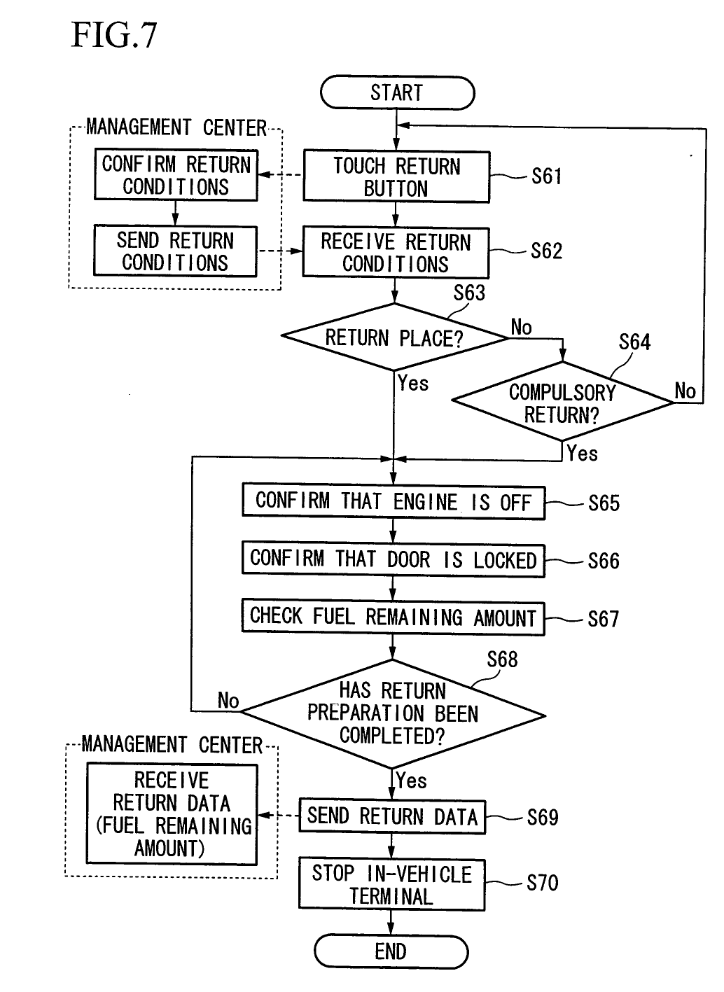

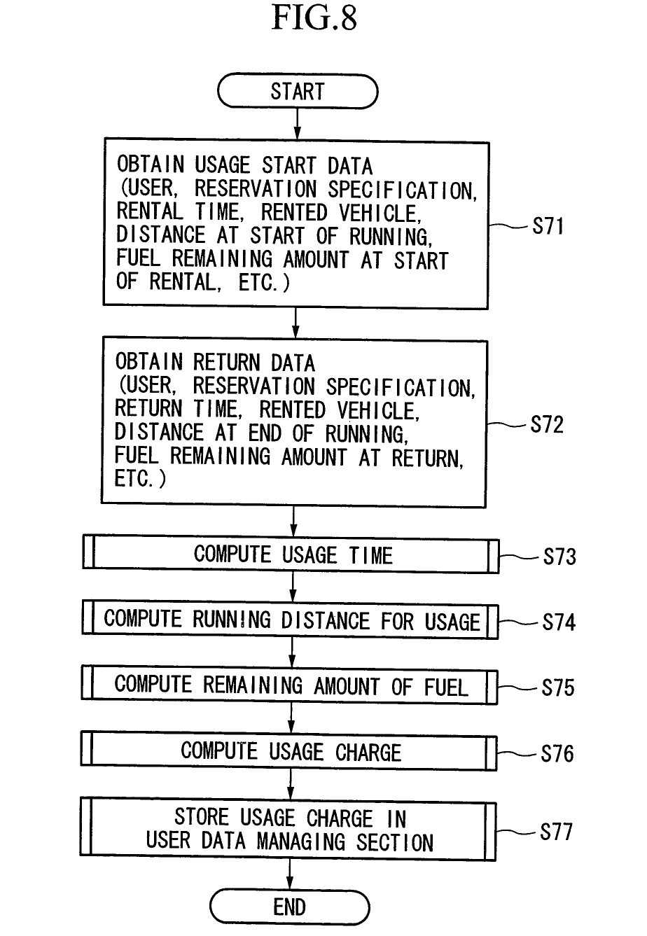

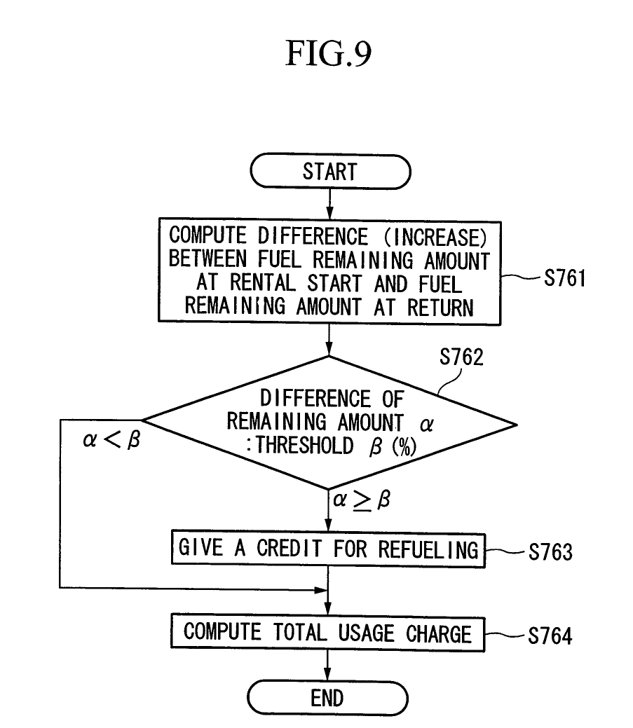

FIGS. 4 to 9 are flowcharts referred to for explaining the operation performed in the present embodiment. FIG. 4 shows a basic operation, FIG. 5 shows a reservation process, FIG. 6 shows a get-in entry process, FIG. 7 shows a vehicle returning process, FIG. 8 shows a usage charge computing process, and FIG. 9 shows a usage charge computing process relating to fueling. In FIGS. 8 and 9, a procedure in the program according to the present invention is also shown.

Below, the operation of the present embodiment shown in FIGS. 1 to 3 will be explained in detail with reference to the flowcharts in FIGS. 4 to 9.

FIG. 4 shows the basic operation relating to the users. First, the staff in the management center 1 or the user operates a shared vehicle reservation terminal so as to access the server 11 (i.e., the vehicle common use system) via the communication network (see step S31). Here, the shared vehicle reservation terminal may be the user terminal 4 possessed by the user 3, or a cellar phone employing WAP or a personal computer having a web function provided at each port. According to the process of step S31, a reservation picture is sent from the server 11, which is displayed on the shared vehicle reservation terminal so as to perform vehicle rental reservation (see steps S32 and S33). The flow of the reservation process executed using the shared vehicle reservation terminal is shown in FIG. 5.

In FIG. 5, in new reservation (see step S331), specific data including personal data of the user are input so as to reserve a vehicle (see step S332), and reservation data are transmitted to the server 11 of the management center 1 by clicking a button for definitely settling the input data (see steps S335 and S336). The server 11 of the management center 1, which received the data, updates databases of the vehicle data managing section 12 and the user data managing section 13 so as to perform reservation.

The server 11 sends a reservation receipt picture data to the shared vehicle reservation terminal which has issued a request. The shared vehicle reservation terminal which received the reservation receipt picture data displays a corresponding picture so as to confirm the reservation (see step S337).

Regarding step S331, if a change is requested in the existing reservation (see step S333), data necessary for changing the reservation is input (see step S334), and the process from step S335 is performed.

The operation shown in FIG. 5 is an optional process which is performed only when the user 3 wishes. The user 3 can directly access a shared vehicle in the port without performing the reservation process as shown in FIG. 5.

Below, the get-in entry process will be explained with reference to the flowchart in FIG. 6.

First, when a user 3 approaches a shared vehicle 2 which is parking in any port, the human body detecting device 25 detects the user 3 approaching the shared vehicle 2, so that the standby release directing device 23 outputs a standby release command to the computer 21. When the computer 21 is activated by the standby release command, the computer 21 establishes communication with the server 11 via the communication device 26 and the communication device 15 of the management center 1.

The user then makes the ID card reading device 24 read the ID card (see step S51). Accordingly, when the user has made a reservation, the ID card reading device 24 reads reservation data written in the ID card, while when the user has made no reservation, the ID card reading device 24 reads rental request data. The ID card reading device 24 sends the computer 21 the read data. The computer 21 communicates with the server 11 of the management center 1 so as to confirm presence/absence of reservation data or possibility of reservation (i.e., whether the vehicle has not been reserved by another user) and collates the data received from the ID card reading device 24 with the data received from the server 11 (see step S52).

If the collated data coincides with each other, that is, when the reservation of the user is confirmed or when it is determined that the shared vehicle can be rented (see step S53), the door lock of the vehicle is released (see step S54) and the display device 29 and the input device 30 are activated (i.e., the in-vehicle terminal is activated) (see step S55). Simultaneously, the password (PW) is confirmed (see step S56) so as to confirm whether the user is a user registered in the computer 21 (see step S57). If it is determined that the user is a registered user, starting of the engine (ENG) is permitted (see step S58), so that usage of the rented vehicle is started (see step S59). In this process, the in-vehicle terminal sends the computer 11 in the management center 1 usage start data including the remaining amount of fuel measured by the fuel remaining amount measuring device 31 (see FIG. 3) via the communication device 26.

Next, the process performed when the rented vehicle is returned will be explained with reference to the flowchart in FIG. 7.

First, the user touches a return button provided in a touch panel of the in-vehicle terminal (see step S61). Accordingly, in the management center 1, return conditions relating to a place to which the rented vehicle is returned or the like are confirmed, and the return conditions are sent to the in-vehicle terminal. The in-vehicle terminal receives the return conditions (see step S62). When the vehicle arrives at the return place (see step S63), the in-vehicle terminal confirms that the engine is off (see step S65) and that the door is locked (see step S66), and checks the remaining amount of fuel (see step S67). When return preparation has been completed, the in-vehicle terminal sends return data to the management center 1 (see steps S68 and S69). The return data include data relating to the remaining amount of fuel at the time of the return, measured by the fuel remaining amount measuring device 31. The operation of the in-vehicle terminal is then stopped (see step S70).

If compulsory return is directed by the computer 11 of the management center 1 for a reason of reservation expiration or the like (see step S64), the process from the above-explained step S65 is performed. In addition, refueling by the user is performed in a suitable period of time within the period from the start of usage to the return of the rented vehicle (this process is not shown in the flowcharts of FIGS. 6 and 7).

Among the processes in FIG. 7, those performed by the management center 1 may be performed by the computer 21 of the vehicle 2. In this case, designation of compulsory return is not performed.

Below, the process of computing the usage charge, performed by the server 11 of the management center 1, will be explained with reference to the flowchart in FIG. 8.

First, the server 11 obtains usage charge start data (see step S71) at a timing when the user 3 starts usage of a rental vehicle (see step S59 in FIG. 6). The usage charge start data relate to user, reservation specification, rental time, rented vehicle, distance at the start of running, remaining amount of fuel at the start of rental, etc. In the next step, the server 11 obtains the return data (see step S72) at a timing when the in-vehicle terminal sends the return data at the return of the rented vehicle (see step S69 in FIG. 7). The return data relate to user, reservation specification, return time, rented vehicle, distance at the end of running, remaining fuel at the time of return, etc.

The server 11 computes rental (or usage) time (see step S73), running distance for usage (see step S74), and remaining amount of fuel (see step S75) based on the data for the time, the distance, and the remaining amount of fuel after and before of usage, obtained in the steps S71 and S72.

In the computation of the usage charge, as shown in the flowchart in FIG. 9, the difference between the remaining amount of the fuel at the rental start and the remaining amount of the fuel at the return (i.e., an increase from the remaining amount of the fuel at the rental start to the remaining amount of the fuel at the return) is computed (see step S761), and the obtained difference of the remaining amount is compared with a threshold β (see step S762). Here, the quantity of fuel is indicated, not by using an absolute value, but by using a percent value; thus, a correction process is also performed in consideration of differences between vehicles and between capacities of tanks of the vehicles. When the above difference between the remaining amounts is equal to or greater than a predetermined value (i.e., threshold β, e.g., 30%), a suitable credit is given for fueling by the user and the charge is adjusted with respect to the credit (see step S763). In the last step, the adjusted charge is written into the user data managing section 13, and the charge computing process is completed (see steps S77 and S764).

Regarding the operation shown in FIG. 8, the charge computing process may be performed by the computer 21 of the vehicle 2 without performing communication with the server 11 except for receiving data with respect to the usage charge from the server 11. Accordingly, instead of determination for giving a credit performed in step S762, it is preferable to give a credit when the following two applicable conditions are satisfied.

More specifically, when (i) the remaining amount of fuel at the return is equal to or greater than a reference value for return (e.g., 75%) (i.e., the first applicable condition) and (ii) the decreased remaining amount of fuel, measured when the engine is stopped, is lower than a reference value for decrease (e.g., 50%) (i.e., the second applicable condition), a credit is given to the user. Regarding the second applicable condition, engine OFF (i.e., the engine is stopped) is necessary for refueling on view of safety; thus, increase in the fuel may be checked when the engine is switched from OFF to ON (i.e., the engine is operated).

The above determination for giving a credit will be further explained with reference to Tables 1 and 2.

TABLE 1

| event | ex. 1 | ex. 2 | ex. 3 | ex. 4 | ex. 5 |
|---|---|---|---|---|---|
| engine ON at start of trip | 20 | 20 | 80 | 20 | 20 |
| first engine OFF | 15 | 15 | 65 | 15 | 15 |
| second engine ON | 15 | 15 | 65 | 100 | 100 |
| second engine OFF | — | — | — | — | — |
| (n − 1)th engine OFF | 10 | 10 | 55 | 40 | 60 |
| nth engine ON | 100 | 100 | 100 | 100 | 100 |
| engine OFF one time before end of | 70 | 90 | 90 | 70 | 90 |
| trip | | | | | |
| final engine ON | 70 | 90 | 90 | 70 | 90 |
| engine OFF at end of trip | 65 | 80 | 80 | 65 | 80 |

In Table 1, the upper-end horizontal column shows rented vehicles (examples 1 to 5) and the left-end vertical column shows events during running (i.e., engine ON/OFF), and at each crossing, the measured remaining amount (%) is shown. In this case shown in Table 1, which vehicle is given a credit will be explained.

First, it is determined for each vehicle whether the remaining amount measured “when the engine is OFF after the end of trip” (which is the last event) is equal to or greater than the reference value for the remaining amount at the return. Here, the vehicles of examples 1 and 4 do not satisfy the first applicable condition; thus, no credit is given.

Next, it is determined whether the decreased remaining amount of fuel, measured during the usage of the vehicle 2, is lower than the reference value for decrease (in this case, 50%). Here, the decreased remaining amount of the example 3 is 55%; thus, the second applicable condition is not satisfied and no credit is given.

Therefore, the vehicles of examples 2 and 5 satisfy both applicable conditions, and a credit is given to each of these vehicles, as shown in Table 2.

TABLE 2

| | ex. 1 | ex. 2 | ex. 3 | ex. 4 | ex. 5 |
|---|---|---|---|---|---|
| determined results | not given | given | not given | not given | given |

In other words, in the state in which the second applicable condition is also satisfied while the first applicable condition is satisfied, fuel of a fixed quantity or more is supplied at least one time while the vehicle 2 is used (i.e., rented). Therefore, as the second applicable condition, it may be determined whether (i) fueling was performed at least one time before the return of the vehicle and (ii) fuel has been increased to a reference value at return (e.g., 50%) or more.

As explained above, in the present invention, the remaining amount at the start of usage (i.e., rental) is compared with the remaining amount at the return, and if the difference between the remaining amounts (i.e., an increase from the remaining amount at the start of usage to the remaining amount at the return) is equal to or greater than a predetermined value, a credit is given to the user and the charge is adjusted for the credit. Accordingly, refueling by the user for the returned vehicle is promoted, thereby reducing the labor of the maintenance staff.

Therefore, the user benefits from a discounted charge, which promotes a system of returning the vehicle after refueling, thereby saving the labor of the maintenance staff. In addition, when refueling is performed at a contract station, the vehicle is checked by a service person at the station, thereby reducing the burden on the maintenance staff. Furthermore, the vehicle can be checked at each time of fueling, thereby improving efficiency of the usage of the rental vehicle.

The process executed by the charge computing device may be stored in a computer readable storage medium, and this stored program may be loaded and executed on a computer system, thereby realizing the vehicle common use system according to the present invention.

The above computer system includes an operating system (OS) and hardware resources such as peripheral devices and the like.

If the computer system employs a WWW (world wide web) system, the home page providing environment (or display environment) is also included in the computer system.

The above program may be transmitted from a computer system which stores this program in a storage device or the like, via a transmission medium (on transmission waves through the transmission medium) to another computer system. The transmission medium through which the program is transmitted may be a network such as the Internet or a communication line such as a telephone line, that is, a medium which has a function for transmitting data.

In addition, the above program may realize a part of the above-explained functions, or may be provided as a “differential” file (i.e., differential program) which is combined with an existing program which has already been stored in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A vehicle common use system for managing rental and return of a vehicle, the system comprising:
a usage charge computing device for receiving a remaining amount of fuel at a start of rental of the vehicle and a remaining amount of fuel at the return of the vehicle, from an in-vehicle terminal which is mounted on the vehicle and is connected via a communication network, and for giving a credit for fueling of the vehicle by a user when an increase in the remaining amount of fuel from the start of rental to the return, which is obtained by comparing both remaining amounts of fuel, is equal to or greater than a predetermined value.

2. A vehicle common use system as claimed in claim 1, wherein the usage charge computing device receives the remaining amount of fuel at the return of the vehicle via the in-vehicle terminal from a fuel remaining amount measuring device for measuring a remaining amount of fuel, provided in the vehicle, wherein the remaining amount of fuel at the return is a part of rental end data obtained when the vehicle is returned.

3. A vehicle common use system as claimed in claim 1, wherein the usage charge computing device receives the remaining amount of fuel at the start of rental of the vehicle and the remaining amount of fuel at the return of the vehicle, which are measured by a fuel remaining amount measuring device, provided in the vehicle, for measuring a remaining amount of fuel, wherein the former remaining amount is a part of rental data obtained when the vehicle is rented and the latter remaining amount is a part of rental end data obtained when the vehicle is returned.

4. A vehicle common use method for managing rental and return of a vehicle by using a computer, the method comprising the steps of:
receiving a remaining amount of fuel at a start of rental of the vehicle and a remaining amount of fuel at the return of the vehicle, from an in-vehicle terminal which is mounted on the vehicle and is connected via a communication network; and
giving a credit for fueling of the vehicle by a user when an increase in the remaining amount of fuel from the start of rental to the return, which is obtained by comparing both remaining amounts of fuel, is equal to or greater than a predetermined value.

5. A program used in a vehicle common use system for managing rental and return of a vehicle, the program for making a computer execute the steps of:
receiving a remaining amount of fuel at a start of rental of the vehicle and a remaining amount of fuel at the return of the vehicle, from an in-vehicle terminal which is mounted on the vehicle and is connected via a communication network; and
giving a credit for fueling of the vehicle by a user when an increase in the remaining amount of fuel from the start of rental to the return, which is obtained by comparing both remaining amounts of fuel, is equal to or greater than a predetermined value.

6. A vehicle common use system for managing rental and return of a vehicle, the system comprising in the vehicle:
a remaining amount measuring device for measuring a remaining amount of fuel at the return of the vehicle;
a decreased fuel remaining amount measuring device for measuring a decreased remaining amount of fuel when an engine of the vehicle is stopped during usage of the vehicle;
a fueling credit producing device for giving a credit for fueling of the vehicle by a user when the decreased remaining amount of fuel, measured by the decreased fuel remaining amount measuring device, is less than a predetermined value and the remaining amount of fuel at the return of the vehicle, measured by the remaining amount measuring device, is equal to or greater than a second predetermined value; and
a usage charge computing device for computing a usage charge based on a signal which indicates giving of the credit and is issued from the fueling credit producing device, and on data which relates to the usage charge and is provided from a server connected via a communication network.
